(19) United States
(12) Patent Application Publication
(10) Pub. No.: US 2026/0348442 A1
(43) Pub. Date: Nov. 5, 2026

(54) SURFACE COATINGS FOR BRAKE PADS

(71) Applicant: Robert Bosch GmbH, Stuttgart (DE)

(72) Inventors: Zhigang Wang, Willowbrook, IL (US); Mark Phipps, Wayne, IL (US)

(21) Appl. No.: 19/189,462

(22) Filed: Apr. 25, 2025

(51) Int. Cl. F16D 69/02; F16D 65/092; F16D 69/04

(52) U.S. Cl. CPC F16D 69/025; F16D 65/092; F16D 69/0408; F16D 2069/0458; F16D 2200/0078; F16D 2250/0046; F16D 2250/0069

(57) ABSTRACT

Disclosed herein are brake pads that have advantageous surface coatings that can extend brake pad life and can reduce the high-frequency vibration in braking without sacrificing friction performance. An example brake pad includes a backing plate, a friction lining on the backing plate, and a surface coating on the friction lining, where the surface coating includes an adhesive, a lubricant, an iron oxide, an abrasive, and a filler. Also disclosed are methods of making the brake pads.

### TECHNICAL FIELD

This disclosure relates to surface coatings for brake pads.

### INTRODUCTION

Brake pads used in motor vehicles undergo a “bedding-in” process that involves a gradual deposition of friction material onto the surface of the brake rotor. New materials and compositions that can facilitate the bedding-in process could be beneficial for brake pad performance and life span.

### SUMMARY

In one aspect, disclosed are brake pads including a backing plate; a friction lining affixed to a surface of the backing plate; and a coating on a surface of the friction lining, the coating including an adhesive, a lubricant, an iron oxide, an abrasive, and a filler.

In another aspect, disclosed are methods of making a brake pad, the method including hot pressing a friction lining to a surface of a backing plate; heating the backing plate and the friction lining; and applying a coating to a surface of the friction lining, the coating including an adhesive, a lubricant, an iron oxide, an abrasive, and a filler.

### BRIEF DESCRIPTION OF THE DRAWINGS

FIG. 1 is a perspective view of an example brake pad including a surface coating.

FIG. 2 is a plot showing Section 1.0 Green Effectiveness of the SAE J 2522 performance test, which includes 30 snubs 80 to 30 km/h at 3,000 kP a. “Snub” refers to not stopping the dynamometer (dyno) to zero, e.g., reducing the dyno high speed to lower speed, but not to zero. Closed diamonds denote a semi-metallic brake pad without a coating. Open squares denote an example semi-metallic brake pad with a disclosed coating. This notation is used throughout FIG. 2-FIG. 14.

FIG. 3 is a plot showing Section 2.0 Burnish of the SAE J 2522 performance test, which includes 192 snubs 80 to 30 km/h at varying pressures.

FIG. 4 is a plot showing Section 3.0 Characteristic Check of the SAE J 2522 performance test, which includes 6 snubs 80 to 30 km/h at 3 000 kP a.

FIG. 5 is a plot showing Section 4.0 Speed-Pressure Sensitivity Sections of the SAE J 2522 performance test. The far left is Section 4.1 Speed/Pressure Sensitivity 40 km/h, which includes 8 stops 40 to 5 km/h at increasing pressures. Second over from left is Section 4.2 Speed/Pressure Sensitivity 80 km/h, which includes 8 snubs 80 to 40 km/h at increasing pressures. Three over from the left is Section 4.3 Speed/Pressure Sensitivity 120 km/h, which includes 8 snubs 120 to 80 km/h at increasing pressures. Second over from the right is Section 4.4 Speed/Pressure Sensitivity 160 km/h, which includes 8 snubs 160 to 130 km/h at increasing pressures. The far right is Section 4.5 Speed/Pressure Sensitivity 200 km/h, which includes 8 snubs 200 to 170 km/h at increasing pressures.

FIG. 6 is a plot showing Section 5.0 Characteristic Check of the SAE J 2522 performance test, which includes 6 snubs 80 to 30 km/h at 3,000 kPa.

FIG. 7 is a plot showing Section 6.0 Cold Application (pressure controlled-left) of the SAE J 2522 performance test, which includes 1 stop 40 to 5 km/h at 3 000 kPa, and Section 7.0 Motorway Applications (Deceleration Controlled-right) of the SAE J 2522 performance test, which includes 1 stop and 1 snub at 0.6 g.

FIG. 8 is a plot showing Section 8.0 Characteristic Check (Pressure Controlled) of the SAE J 2522 performance test, which includes 18 snubs 80 to 30 km/h at 3,000 kP a.

FIG. 9 is a plot showing Section 9.0 Fade 1 (Deceleration Controlled-left) of the SAE J 2522 performance test, which includes 15 stops 100 to 5 km/h at 3.92 m/s² and increasing initial temperatures, and Section 10.0 Recovery 1 (Pressure Controlled-right) of the SAE J 2522 performance test, which includes 18 snubs 80 to 30 km/h at 3,000 kPa.

FIG. 10 is a plot showing Section 11.0 Temperature/Pressure Sensitivity 100 °C/80 °C (Pressure Controlled) of the SAE J 2522 performance test, which includes 8 snubs 80 to 30 km/h at increasing pressure.

FIG. 11 is a plot showing Section 12.0 Temperature/Pressure Sensitivity 500 °C/300 °C Sections (Pressure Controlled) of the SAE J 2522 performance test. The left is Section 12.1 Increasing Temperature 500 °C/300 °C, which includes 9 snubs 80 to 30 km/h at increasing temperature. The right is Section 12.2 Pressure Line 500 °C/300 °C, which includes 8 snubs 80 to 30 km/h at increasing pressure.

FIG. 12 is a plot showing Section 13.0 Recovery 2 of the SAE J 2522 performance test, which includes 18 snubs 80 to 30 km/h at 3,000 kP a.

FIG. 13 is a plot showing Section 14.0 Fade 2 of the SAE J 2522 performance test, which includes 15 stops 100 to 5 km/h at 3.92 m/s² and increasing initial temperatures.

FIG. 14 is a plot showing Section 15.0 Recovery 3 of the SAE J 2522 performance test, which includes 18 snubs 80 to 30 km/h at 3,000 kP a.

### DETAILED DESCRIPTION

As discussed elsewhere herein, brake pads used in motor vehicles undergo a “bedding-in” process that involves a gradual deposition of friction material onto the surface of the brake rotor. This gradual deposition of friction material can be referred to as a transfer layer and can help brake pads behave more efficiently and transfer braking power more smoothly. However, the bedding-in of new brake pads and rotors should be done carefully and slowly to transfer an even layer of brake pad material onto the brake rotor. If done improperly, a brake system may suffer rapid heat build-up during the bedding-in process, which may lead to uneven transfer film deposits and possibly cause damage to the brake rotor from warping. The brake pads may also suffer from a “glazing” of the surface material if exposed to excessive heat build-up, reducing the efficiency of the brakes, and diminishing the operational lifespan of the brake pads. Finally, without a proper bedding-in process, pad material may accumulate unevenly on the rotor, which can manifest as high-frequency vibration. High-frequency vibration results in noise, particularly in wet conditions.

Disclosed herein are brake pad surface coatings that can improve the bedding-in process, which in turn can form a more even transfer layer between the brake pad and the rotor. Ultimately, the disclosed surface coatings can extend brake pad life up to 40% longer & reduce the high-frequency vibration in braking without sacrificing friction performance. In addition, while most brake pads will take up to 300-400 miles to fully develop an even transfer layer onto the rotors, the disclosed brake pads can accomplish a fully developed, even transfer layer onto the rotor in significantly less time.

### 1. Definitions

Unless otherwise defined, all technical and scientific terms used herein have the same meaning as commonly understood by one of ordinary skill in the art. In case of conflict, the present document, including definitions, will control. The materials, methods, and examples disclosed herein are illustrative only and not intended to be limiting. Methods and materials similar or equivalent to those described herein can be used in practice or testing of the disclosed technology. All publications, patent applications, patents and other references mentioned herein are incorporated by reference in their entirety.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the numbers 6.0, 6.1, 6.2, 6.3, 6.4, 6.5, 6.6, 6.7, 6.8, 6.9, and 7.0 are contemplated, and for the range 1.5-2, the numbers 1.5, 1.6, 1.7, 1.8, 1.9, and 2 are contemplated.

Definitions of specific functional groups and chemical terms are described in more detail below. For purposes of this disclosure, the chemical elements are identified in accordance with the Periodic Table of the Elements, CAS version, Handbook of Chemistry and Physics, 75th Ed., inside cover, and specific functional groups are generally defined as described therein.

### 2. Brake Pads

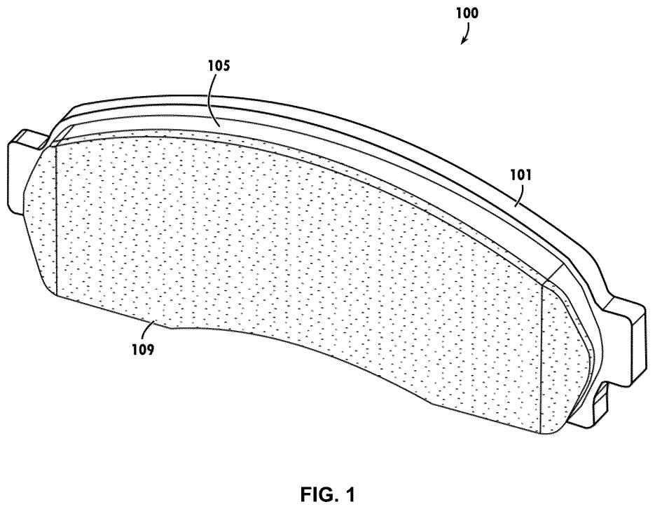

Disclosed herein are brake pads 100 with coatings that can provide improved performance. As shown in FIG. 1, the brake pad 100 includes a backing plate 101, a friction lining 105, and a coating 109. The coating 109 can be included on a surface of the friction lining 105, which in turn can be affixed to a surface of the backing plate 101. The coating 109 can improve the bedding-in process, e.g., between a brake pad and a rotor. In particular, the coating 109 can provide an even transfer between the brake pad 100 and a rotor, which, ultimately, can extend the life of the brake pad, as well as can reduce unwanted brake noise behavior.

During normal braking operations, the friction lining of a brake pad can wear away and may leave residual material on the surface of a rotor during a bedding-in period of operation. This residual material is known as a “transfer layer” and a properly developed transfer layer can improve the efficiency of braking, the smoothness of the braking force application, and the operable lifespan of the brake pad. The transfer layer can also reduce heat build-up during braking, which may prevent damage to the brake rotor or detrimental effects of heat on the friction lining. However, because friction lining is formulated to resist wear, the bedding-in process may take longer than desired. For this reason, the disclosed brake pad 100 includes a surface coating applied to a surface of the friction lining 105 that can facilitate the formation of the transfer layer.

The coating 109 can be on a surface of the friction lining 105. The coating 109 can be adhered/affixed to the surface of the friction lining 105, e.g., through an adhesive. The friction lining 105 can be made through powder metallurgy techniques. The friction lining 105 can be porous, and the coating 109 can penetrate the pores of the friction lining 105. Pores can be generated in the friction lining 105 through the use of a polymer resin (e.g., Novolac phenolic resin), which can act as a binder. For example, at high temperatures, such as those used in powder metallurgy, the polymer resin can become tacky and its viscosity can increase. This can result in decreased interactions with other components of the friction lining 105, such as particles and fibers, which can create nano- and micro-cale voids/pores within the friction lining 105. Alternatively, the polymer resin can react with a compound, such as hexamethylenetetramine, to generate volatile compounds, such as ammonia. These volatile compounds can give rise to pores within the friction lining 105.

The friction lining 105 and/or the surface of the friction lining 105, can include a material that is also present in the coating 109. For example, the friction lining 105 can include an adhesive, a lubricant, an iron oxide, an abrasive, a filler, a binder, or a combination thereof. In some embodiments, the friction lining 105 includes all the same materials of the coating 109, but also including a binder. Further description of the adhesive, the lubricant, the iron oxide, the abrasive, and the filler can be found below in the description of the coating 109. Because the friction lining 105 can include a combination of metallic materials (e.g., iron oxide) and non-metallic materials (e.g., fillers), the friction lining 105 can include a semi-metallic material.

The friction lining 105 may be operable to apply friction forces to a braking rotor, thus creating braking power for a vehicle. Friction forces of the friction lining 105 can be transferred via a tribological surface of the friction lining 105. The friction lining 105 therefore can include a tribological surface. The friction lining 105, as part of an automative brake system, can have stable friction, minimal vibration and noise, and low wear rate for the rotor and friction lining 105. The friction lining 105 can also be designed to have a friction coefficient that remains stable under varying conditions including, but not limited to, high and low temperatures, high and low humidity, high and low speed stops, high and low deceleration rates, and varied stop frequency.

The friction lining 105 can be affixed to a surface of the backing plate 101. This surface can also be referred to as a mounting surface of the backing plate 101. The friction lining 105 can be affixed to the surface of the backing plate 101 such that the tribological surface is parallel to the surface of the backing plate 101 within a specified tolerance. “Specified tolerance,” as used herein, refers to the acceptable standard deviation of the thickness of the friction lining 105, with the goal of having a uniform thickness or, e.g., a uniform thickness within a specific tolerance. For example, a friction lining 105 with a target thickness of 12 mm would be within a specified tolerance if the thickness of the friction lining 105 was 12 mm+0.15 mm. The backing plate 101 of the brake pad can function as a mechanical support for the friction lining 105. The backing plate 101 can provide appropriate stiffness and can transfer appropriate mechanical force for the brake pad to apply braking force on the rotor. The backing plate 101 can be made of steel, e.g., can include steel. The backing plate 101 can also aid in the transfer and dissipation of heat that can be produced during braking.

### A. Coatings

The coating 109 can include an adhesive, a lubricant, an iron oxide, an abrasive, a filler, and combinations thereof. The coating 109 can be advantageously formulated to readily create a transfer layer having characteristics similar to that of the friction lining 105. The transfer layer generated by the coating 109 can exhibit friction characteristics similar to a transfer layer generated by the friction lining 105 alone, except the transfer layer may be generated at substantially lower levels of heat and substantially less braking cycles than the friction lining 105 alone. As a result, the brake rotor may be protected from heat-related warping, and the friction lining 105 may be protected from adverse conditions caused by heat buildup during the bedding-in process. In addition, the coating 109 may improve braking performance, noise reduction, and effective lifespan of the brake pad.

The coating 109 may be applied to the entirety of the surface of the friction lining 105. Other embodiments may include different applications, which may advantageously be utilized to accommodate different vehicle specifications. For example, some embodiments may concentrate the coating 109 on portions of the surface of the friction lining 105 that make more frequent contact with a brake rotor during operation. In some embodiments, portions of the surface of the friction lining 105 experience more friction forces during operation may feature a concentration of the coating 109. Other example coating 109 applications include, but are not limited to, spaced circles (e.g., two circles), spaced rings (e.g., two rings), horizontal or vertical stripes (e.g., two stripes, three stripes, four stipes, and the like), angled stripes (e.g., pair of angled stripes), asymmetrically application, grid of hexagons (e.g., honeycomb) where the coating 109 can be the hexagons or the area between the hexagons. Other embodiments may include other configurations without deviating from the teachings disclosed herein.

Application of the coating 109 may be applied using a stamping operation, which is operable to accommodate a wide variety of application designs. A stamping operation may advantageously permit utilization of any arbitrary design desired during manufacturing. The coating 109 can also be applied to the surface of the friction lining 105 through coating processes known within the art such as, but not limited to, spray coating, roll coating, and dip coating.

The coating 109 can provide a distinct visual appearance to the friction lining 105, making the design of the application visually identifiable. Such visual distinction may advantageously permit the coating 109 to be applied to the friction lining 105 in a way that allows for branding in addition to operational advantages. Application of the coating 109 may utilize an arbitrary design. For example, a design may be sold with a particular aesthetic or trademarked design to identify a brake pad as having been made by a particular manufacturer.

The adhesive can allow the coating 109 to be adhered/affixed to the friction lining 105. Example adhesives include, but are not limited to, a wood glue, a polymer resin, and combinations thereof. The polymer resin can be a liquid. Example polymer resins include, but are not limited to, a phenolic resin, an acrylic resin, an epoxy resin, and combinations thereof. In some embodiments, the adhesive includes a wood glue or a polymer resin. In some embodiments, the adhesive is a wood glue or a polymer resin. In some embodiments, the adhesive is a wood glue, a phenolic resin, or an acrylic resin.

The adhesive may be formulated for a specified curing time that is suitably long for a complete application, but sufficiently short that addition of the coating 109 to the brake pad 100 has a minimized impact on manufacturing and production times. In some embodiments, the curing time is 180 seconds or less, 160 seconds or less, 140 seconds or less, 120 seconds or less, 100 seconds or less, 80 seconds or less, or 60 seconds or less. In some embodiments, the curing time is 10 seconds or greater, 20 seconds or greater, 30 seconds or greater, 40 seconds or greater, or 50 seconds or greater. In some embodiments, the curing time is about 10 seconds to about 200 seconds, such as about 30 seconds to about 190 seconds, or about 50 seconds to about 180 seconds.

The coating 109 can include the adhesive in a varying amount. For example, the coating 109 can include the adhesive at about 50 weight percent (wt %) to about 85 wt %, such as about 55 wt % to about 80 wt %, about 60 wt % to about 80 wt %, about 62 wt % to about 78 wt %, about 50 wt % to about 78 wt %, about 50 wt % to about 65 wt %, about 64 wt % to about 85 wt %, or about 70 wt % to about 85 wt %. In some embodiments, the coating 109 includes the adhesive at no less than 50 wt %, no less than 55 wt %, no less than 60 wt %, no less than 65 wt %, no less than 70 wt %, or no less than 75 wt %. In some embodiments, the coating 109 includes the adhesive at no more than 85 wt %, no more than 80 wt %, no more than 75 wt %, no more than 70 wt %, no more than 65 wt %, or no more than 60 wt %. The foregoing percentages in reference to the adhesive denote percentage by weight of the coating 109.

The lubricant is a material that can modify friction and wear between moving surfaces, as well as can stabilize the developed friction coefficient during braking, particularly at high temperature. Lubricants work by being able to create a film between the surfaces, which can minimize direct contact and can reduce the force required for movement. Useful functions of the lubricant in friction materials include but are not limited to: (1) can modify friction; (2) can prevent and/or decrease wear, and (3) can dissipate heat, which can minimize overheating and damage to the materials of a brake system. Example lubricants include, but are not limited to, an iron sulfide, a tin sulfide, and combinations thereof. Example iron sulfides include FeS, Fe₂S₃, and Fe₃S₄. Example tin sulfides include SnS and SnS₂. In some embodiments, the lubricant includes a metal sulfide. In some embodiments, the lubricant includes one or more metal sulfides, such as one metal sulfide, two different metal sulfides, three different metal sulfides, and so on. In some embodiments, the lubricant includes an iron sulfide, a tin sulfide, a combination of iron sulfides, a combination of tin sulfides, or a combination thereof. In some embodiments, the lubricant includes FeS, Fe₂S₃, SnS, SnS₂, or a combination thereof. In some embodiments, the lubricant is FeS, Fe₂S₃, SnS, SnS₂, or a combination thereof.

The coating 109 can include the lubricant in a varying amount. For example, the coating 109 can include the lubricant at about 0.5 wt % to about 6 wt %, such as about 1 wt % to about 6 wt %, about 0.75 wt % to about 5 wt %, about 1 wt % to about 5 wt %, about 1 wt % to about 4 wt %, about 0.5 wt % to about 4 wt %, about 0.5 wt % to about 2 wt %, about 3 wt % to about 6 wt %, or about 4 wt % to about 6 wt %. In some embodiments, the coating 109 includes the lubricant at no less than 0.5 wt %, no less than 0.75 wt %, no less than 1 wt %, no less than 1.5 wt %, no less than 2 wt %, no less than 2.5 wt %, or no less than 3 wt %. In some embodiments, the coating 109 includes the lubricant at no more than 6 wt %, no more than 5.5 wt %, no more than 5 wt %, no more than 4.5 wt %, no more than 4 wt %, no more than 3.5 wt %, or no more than 3 wt %. The foregoing percentages in reference to the lubricant denote percentage by weight of the coating 109.

The iron oxide of the coating 109 can enhance the formation of the transfer film, which can extend the brake pad life and rotor life. In particular, the iron oxide, in combination with the lubricant, can assist transfer film formation during the braking process. Example iron oxides include, but are not limited to, magnetite (iron(II,III) oxide (Fe₃O₄), also called lodestone or magnetic iron ore), iron(III) oxide or ferric oxide (Fe₂O₃), iron(II) oxide (FeO), and combinations thereof. In some embodiments, the iron oxide includes magnetite (Fe₃O₄), iron(III) oxide (Fe₂O₃), iron(II) oxide (FeO), or a combination thereof. In some embodiments, the iron oxide includes FeO, magnetite, Fe₂O₃, or a combination thereof. In some embodiments, the iron oxide is FeO, magnetite, Fe₂O₃, or a combination thereof.

The coating 109 can include the iron oxide in a varying amount. For example, the coating 109 can include the iron oxide at about 5 wt % to about 15 wt %, such as about 6 wt % to about 14 wt %, about 7 wt % to about 13 wt %, about 8 wt % to about 12 wt %, about 5 wt % to about 12 wt %, about 5 wt % to about 10 wt %, about 8 wt % to about 15 wt %, or about 10 wt % to about 15 wt %. In some embodiments, the coating 109 includes the iron oxide at no less than 5 wt %, no less than 6 wt %, no less than 7 wt %, no less than 7.5 wt %, no less than 8 wt %, no less than 9 wt %, or no less than 10 wt %. In some embodiments, the coating 109 includes the iron oxide at no more than 15 wt %, no more than 14 wt %, no more than 13 wt %, no more than 12.5 wt %, no more than 12 wt %, no more than 11 wt %, or no more than 10 wt %. The foregoing percentages in reference to the iron oxide denote percentage by weight of the coating 109.

Abrasives are a group of hard raw materials used to increase the friction coefficient between the brake disk and brake pad. Abrasives, such as mild abrasives, can be used in the coating 109 to generate friction without excessive wear of rotor or lining, and to dynamically control the thickness of transfer film. A desired thickness of transfer films can achieve a balance of friction performance and pad life. Example abrasives include, but are not limited to, zirconium silicate, zirconia, magnesium oxide, silica, silicon dioxide, complex mineral silicates such as calcium magnesium silicate, calcium magnesium zirconium silicate, calcium magnesium aluminum silicate, and magnesium aluminum silicate. In some embodiments, the abrasive includes zirconium silicate, zirconia, a magnesium oxide, a silica, silicon dioxide, a mineral silicate, or a combination thereof. In some embodiments, the abrasive includes zirconium (Zr). In some embodiments, the abrasive includes zirconium silicate, zirconia, or a combination thereof. In some embodiments, the abrasive is zirconium silicate, zirconia, or a combination thereof.

The coating 109 can include the abrasive in a varying amount. For example, the coating 109 can include the abrasive at about 5 wt % to about 15 wt %, such as about 5 wt % to about 14 wt %, about 5 wt % to about 12 wt %, about 5 wt % to about 10 wt %, or about 10 wt % to about 15 wt %. In some embodiments, the coating 109 includes the abrasive at no less than 5 wt %, no less than 5.5 wt %, no less than 6 wt %, no less than 6.5 wt %, no less than 7 wt %, no less than 7.5 wt %, or no less 8 wt %. In some embodiments, the coating 109 includes the abrasive at no more than 15 wt %, no more than 14 wt %, no more than 13 wt %, no more than 12 wt %, no more than 11 wt %, no more than 10.5 wt %, or no more than 10 wt %. The foregoing percentages in reference to the abrasive denote percentage by weight of the coating 109.

Fillers are particles, such as solid particles, used in the coating 109 to improve properties and lower costs. Example fillers include, but are not limited to, baryte, wollastonite, calcium carbonate, calcium fluoride, and combinations thereof. In some embodiments, the filler includes baryte, wollastonite, calcium carbonate, calcium fluoride, or a combination thereof. In some embodiments, the filler includes baryte, wollastonite, or a combination thereof. In some embodiments, the filler includes calcium carbonate, calcium fluoride, or a combination thereof. In some embodiments, the filler includes baryte, wollastonite, calcium carbonate, calcium fluoride, or a combination thereof. In some embodiments, the filler is baryte or wollastonite.

The coating 109 can include the filler in a varying amount. For example, the coating 109 can include the filler at about 1 wt % to about 32 wt %, such as about 1 wt % to about 30 wt %, about 1 wt % to about 25 wt %, about 1 wt % to about 20 wt %, about 1 wt % to about 15 wt %, about 5 wt % to about 20 wt %, about 5 wt % to about 15 wt %, about 8 wt % to about 15 wt %, about 10 wt % to about 15 wt %, about 10 wt % to about 13 wt %, about 10 wt % to about 30 wt %, or about 15 wt % to about 32 wt %. In some embodiments, the coating 109 includes no less than 1 wt %, no less than 5 wt %, no less than 6 wt %, no less than 7 wt %, no less than 8 wt %, no less than 9 wt %, or no less than 10 wt %. In some embodiments, the coating 109 includes no more than 32 wt %, no more than 30 wt %, no more than 25 wt %, no more than 20 wt %, no more than 15 wt %, no more than 14 wt %, no more than 13 wt %, no more than 12 wt %, no more than 11 wt %, or no more than 10 wt %. The foregoing percentages in reference to the filler denote percentage by weight of the coating 109. In some embodiments, the amount of filler present in the coating 109 is the remaining portion after accounting for the adhesive, the lubricant, the iron oxide, and the abrasive.

In some embodiments, the coating 109 does not include a titanate, such as a potassium titanate.

### i. Example Coatings

In some embodiments, the coating 109 includes, by weight of the coating 109, about 50 wt % to about 80 wt % of the adhesive, about 1 wt % to about 6 wt % of the lubricant, about 5 wt % to about 15 wt % of the iron oxide, about 5 wt % to about 15 wt % of the abrasive, and less than 32 wt % of the filler.

In some embodiments, the coating 109 includes, by weight of the coating 109, about 50 wt % to about 80 wt % of the adhesive, about 1 wt % to about 6 wt % of the lubricant, about 5 wt % to about 15 wt % of the iron oxide, about 5 wt % to about 15 wt % of the abrasive, and the balance is the filler.

In some embodiments, the coating 109 includes, by weight of the coating 109, about 50 wt % to about 80 wt % of the adhesive, wherein the adhesive includes a wood glue or a resin polymer; about 1 wt % to about 6 wt % of the lubricant, wherein the lubricant includes FeS, Fe₂S₃, SnS, SnS₂, or a combination thereof; about 5 wt % to about 15 wt % of the iron oxide, wherein the iron oxide includes FeO, magnetite, Fe₂O₃, or a combination thereof; about 5 wt % to about 15 wt % of the abrasive, wherein the abrasive includes zirconia, zirconium silicate, or a combination thereof; and the remaining balance is the filler, wherein the filler includes baryte, wollastonite, or a combination thereof.

In some embodiments, the adhesive includes a wood glue or a resin polymer; the lubricant includes FeS, Fe₂₅₃, SnS, SnS₂, or a combination thereof; the iron oxide includes FeO, magnetite, Fe₂O₃, or a combination thereof; the abrasive includes zirconia, zirconium silicate, or a combination thereof; and the filler includes baryte, wollastonite, or a combination thereof.

### 3. Methods of Making Brake Pads

Also disclosed herein are methods of making the brake pad 100. The method can include providing a backing plate 101. The backing plate 101 can be cleaned via, e.g., derusting and/or degreasing. The method can then include applying the friction lining 105 to the surface of the backing plate 101 (e.g., to the mounting surface). The friction lining 105 can be applied via, e.g., a hot press, which can include pressing the friction lining 105 onto the surface of the backing plate 101 under high temperature and high pressure. Hot pressing is a process similar to powder metallurgy. Hot pressing the friction lining 105 to the surface of the backing plate 101 can affix the friction lining 105 to said surface. The backing plate 101 and the friction lining 105 can then be heated. For example, the backing plate 101 and the friction lining 105 can be heated in an oven. The backing plate 101 with the friction lining 105 affixed thereon can then be machined to desired dimensions.

The method can then include applying the coating 109 (e.g., surface coating) to the surface of the friction lining 105. The coating 109 can be applied via, e.g., a coating process and/or stamping. Different variations in coating design can be used on the surface of the friction lining 105 and is discussed elsewhere herein.

The disclosed technology has multiple aspects, illustrated by the following non-limiting examples.

### 4. Examples

### Example 1

### Example Coating Formulations

Example coating formulations are described below in Table 1.

TABLE 1
Example Coating Formulations (weight percentage)

| | | weight | | weight | | weight |
|---|---|---|---|---|---|---|
| | Formula 1 | amount | Formula 2 | amount | Formula 3 | amount |
| Adhesive | wood | 76% | liquid | 65 | Liquid | 66 |
| | glue | | phenolic | | acrylic | |
| | | | resin | | | |
| Lubricant | FeS | 1% | Fe₂S₃ | 3 | SnS + SnS₂ | 4 |
| Iron Oxide | FeO | 8% | magnetite | 10 | Fe₂O₃ + FeO | 12 |
| Abrasive | Zirconia | 5% | zirconium | 10 | zirconium | 5 |
| | | | silicate | | silicate | |
| Filler | baryte | 10% | wollastonite | 12 | baryte | 13 |

The coating formulations above were made with a liquid coating mixer with one mixing spindle. First, according to the coating formula, a scale was used to measure the correct weight of each raw material including the adhesive. Secondly, the weighted raw materials were put into a coating mixer. Thirdly, the coating mixer mixed all the raw materials to get a homogenous mixture. Fourthly, the material was dispensed from the mixer as needed.

### Example 2

### Example Brake Pad Characterization

Example brake pads were characterized using a 2008-2012 Ford F-350 front friction performance (SAE) 2522 test results) comparison between semi-metallic brake pads with a surface coating vs the same semi-metallic pads without a coating (e.g., baseline). SAE J 2522 is an SAE International recommended practice that details an inertia dynamometer test procedure for evaluating the effectiveness of friction materials used in motor vehicles with hydraulic brake actuation. This test aims to assess the material's performance under various conditions of pressure, temperature, and speed. It's an important and useful method for comparing the performance of different friction materials and establishing quality standards in the brake system industry. The main purpose of SAE J 2522 is to provide a standardized method for assessing brake friction material effectiveness under defined braking conditions. The following are included in the SAE J 2522 test: Test Environment: Inertia dynamometer, simulating real-world braking scenarios. Parameters Evaluated: Pressure, temperature, and speed during brake applications. Applications: Helps brake system manufacturers compare performance, set quality standards, and optimize material selection. Considerations: The test accounts for cooling behavior differences between test stands to ensure accurate comparisons.

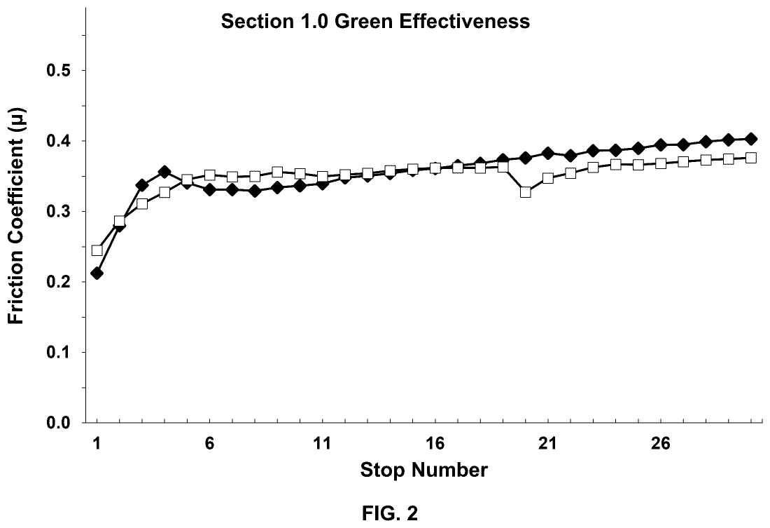

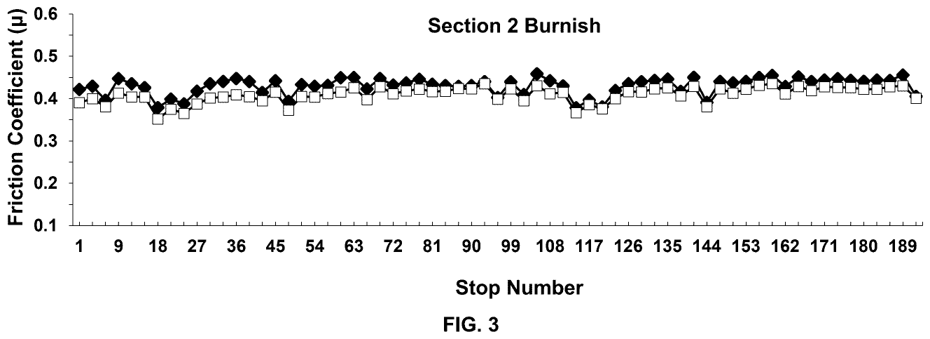

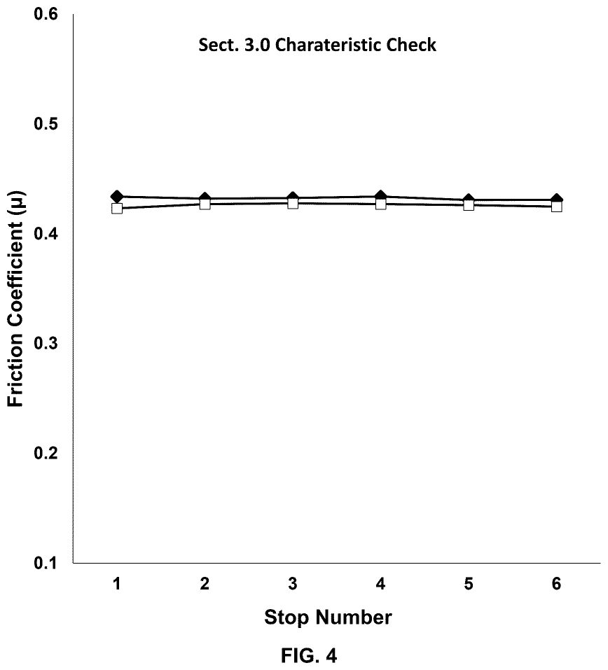

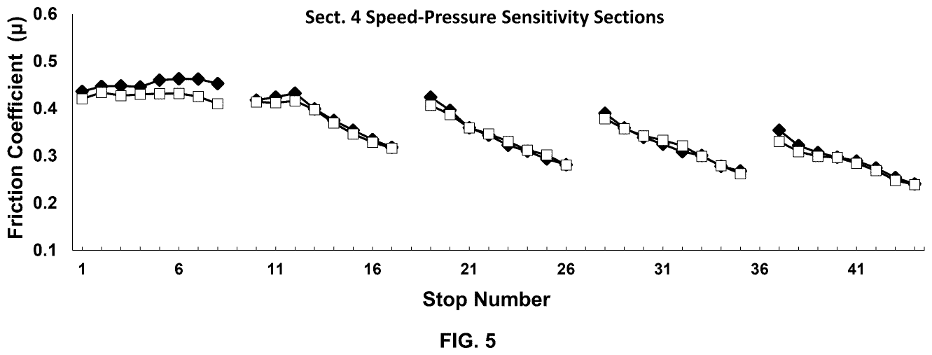

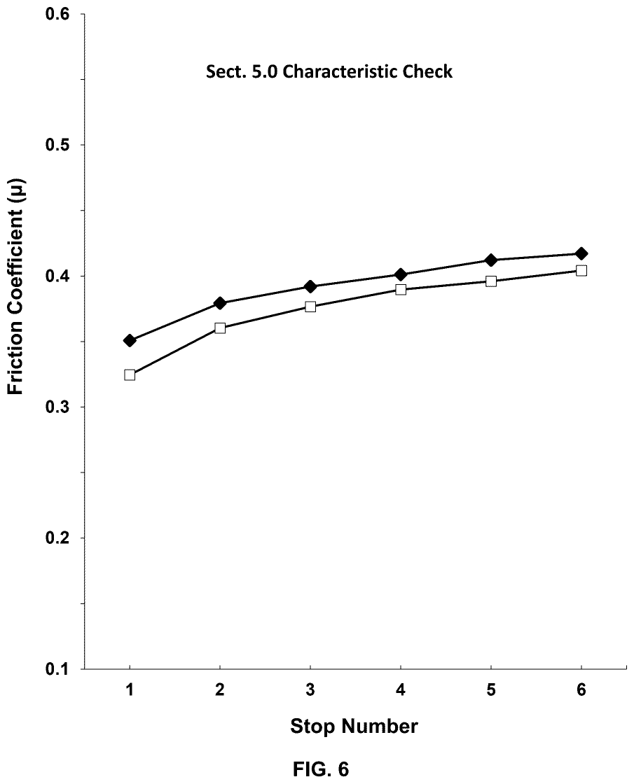

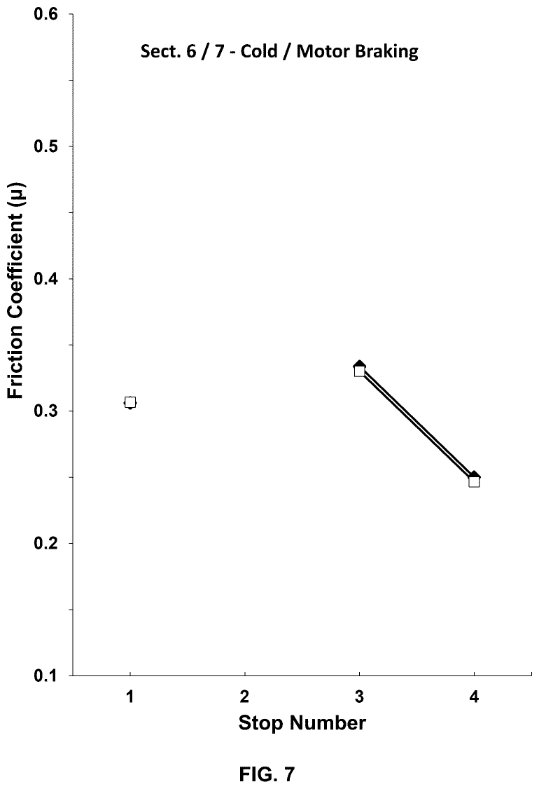

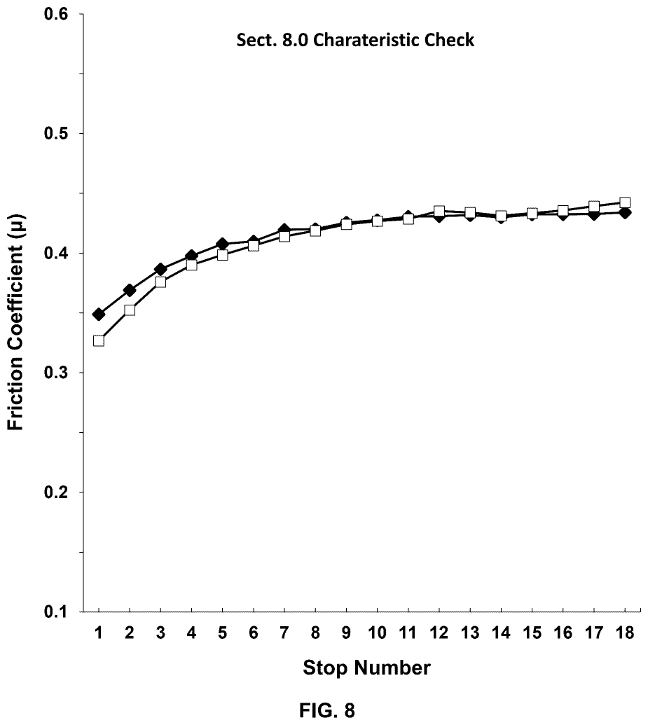

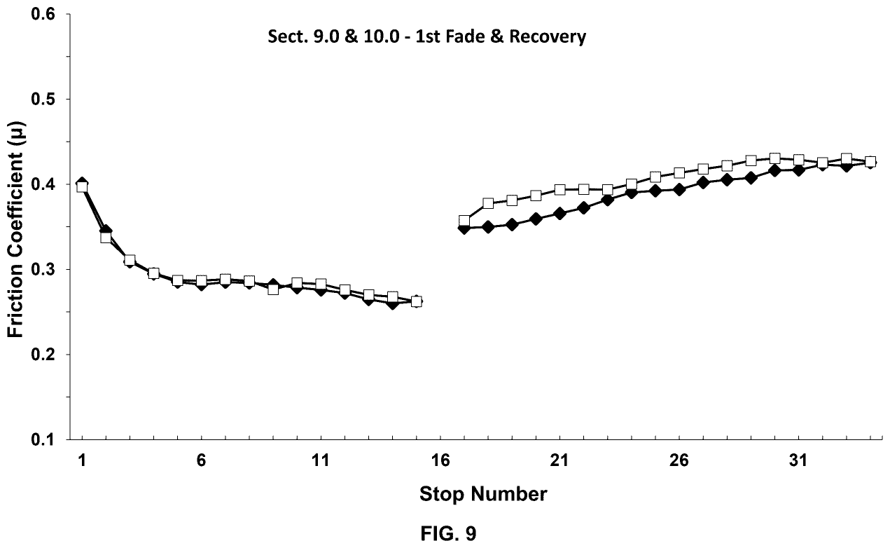

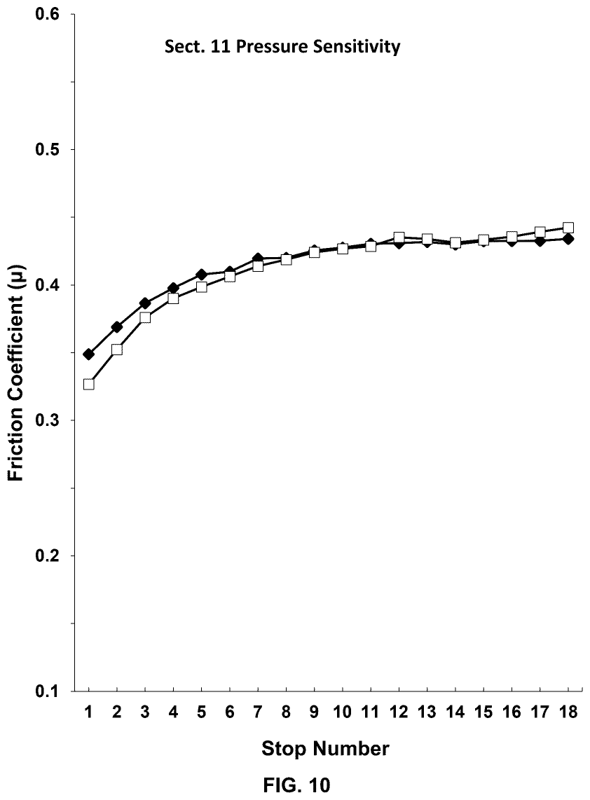

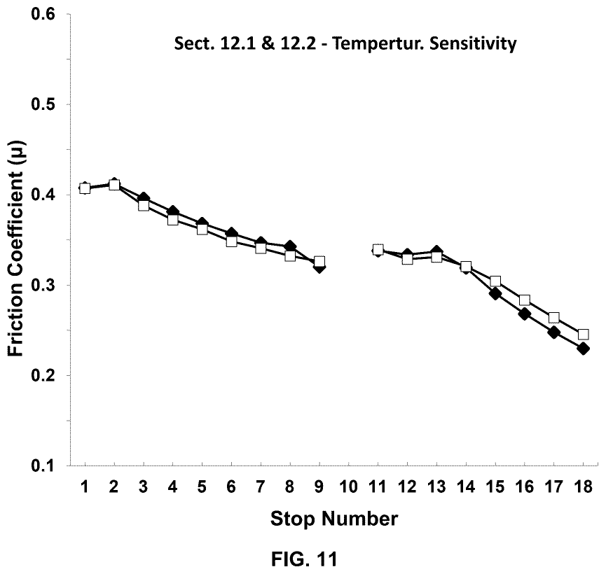

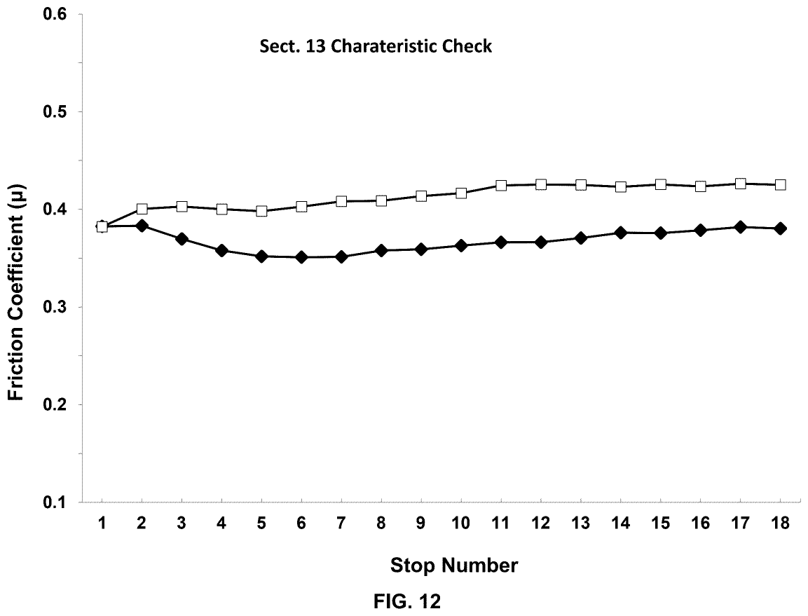

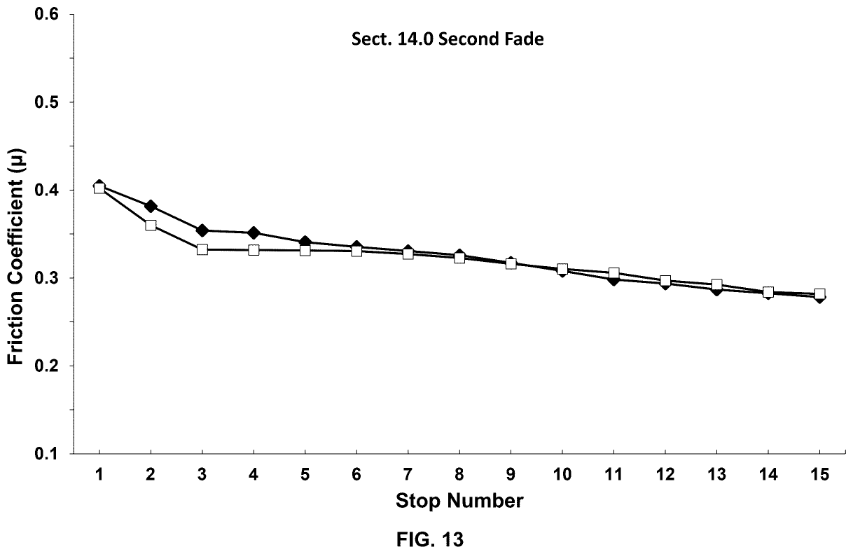

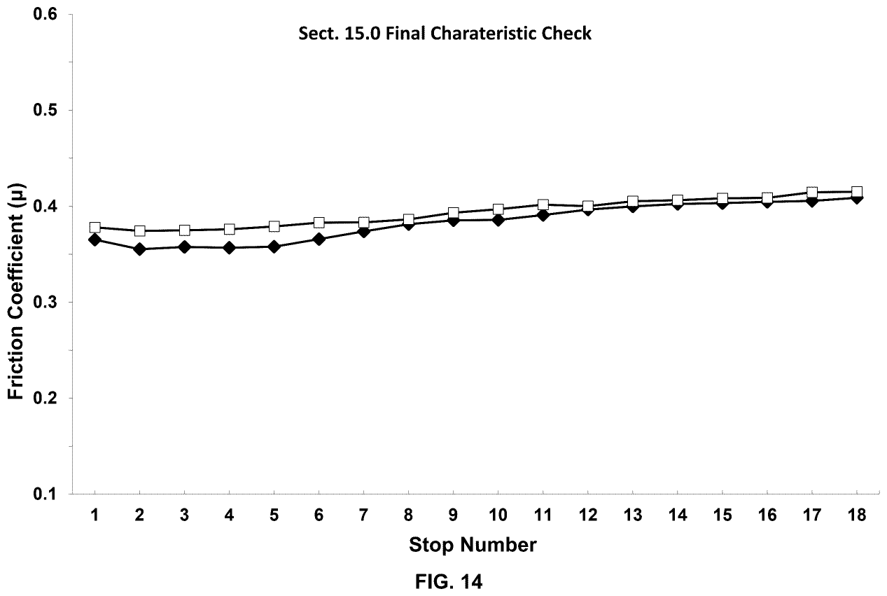

As can be seen in FIG. 2, FIG. 3, FIG. 4, FIG. 5, FIG. 6, FIG. 7, FIG. 8, FIG. 9, FIG. 10, FIG. 11, FIG. 12, FIG. 13, and FIG. 14, the friction performance of semi-metallic brake pads with a surface coating is on par with those of the baseline brake pads. Accordingly, the surface coating has a similar influence on friction as the semi-metallic friction lining.

### Example 3

### Example Brake Pad Noise Behavior

The Los Angeles City Traffic Simulation (LACTS) test is a well-established dynamometer test procedure used to evaluate brake noise and lining wear performance under typical city driving conditions. This procedure is based on a vehicle test conducted on the roads of Los Angeles, California.

In this analysis, brake noise is assessed through the following criteria. Noise index range is 0-10. 10 is the best noise test result, which means the noise behavior of the brake pad is the best. 0 is the worst noise test results. Noise percentage=(number of stops with noise)/(total number of stops in LACTS test) x100%. Max[dB(A)] is high, will lower noise index. Lower number of Max[dB(A)] is better. Noise percentage and Max[dB(A)] have an impact on noise index, high noise percentage or high Max[dB(A)] will lower noise index.

TABLE 2
Comparison of noise behavior of 2008-2012 Ford F-350 Front
in the Los Angeles City Traffic Simulation (LACTS) Tests

| | Noise behavior in USCT | | |
|---|---|---|---|
| | Noise | Noise | Max |
| Friction Material | index | percentage (%) | [dB(A)] |
| semi-metallic without surface coating | 9.5 | 0.06 | 87.6 |
| (baseline) | | | |
| semi-metallic with surface coating | 9.7 | 0.08 | 71.5 |

As shown in Table 2, the surface coating can improve semi-metallic brake pads noise behavior.

### Example 4

### Example Brake Pad Performance

As mentioned above, the Los Angeles City Traffic Simulation (LACTS) test is a well-established dynamometer test procedure used to evaluate brake noise and lining wear performance under a typical city driving conditions. This procedure is based on a vehicle test conducted on the roads of Los Angeles, California.

TABLE 3
Comparisons of pad life & rotor wear of 2008-2012 Ford F-350
Front in the Los Angeles Traffic Simulation (LACTS) Test

| | SLACT test | |
|---|---|---|
| | Predicted average | Rotor Weight |
| Friction Material | pad life (km) | Loss (g) |
| Semi-metallic without coating | 75426 | 2 |
| (baseline) | | |
| Semi-metallic with surface coating | 105830 | 11 |

As shown in Table 3, the surface coating significantly increased the predicted pad life of the semi-metallic brake pads from 75426 km to 105830 km (the increment is about 40%), without sacrificing friction performance and noise performance. Rotor wear was also evaluated by rotor weight loss in LACTS test. The surface coating, which can be black in color, increases pad life of the semi-metallic brake pads, while slightly increasing rotor wear.

It is understood that the foregoing detailed description and accompanying examples are merely illustrative and are not to be taken as limitations upon the scope of the disclosure.

Various changes and modifications to the disclosed embodiments will be apparent to those skilled in the art. Such changes and modifications, including without limitation those relating to the chemical structures, substituents, derivatives, intermediates, syntheses, compositions, formulations, or methods of use of the technology, may be made without departing from the spirit and scope thereof.

For reasons of completeness, the following Embodiments are provided.

Clause 1. A brake pad comprising: a backing plate; a friction lining affixed to a surface of the backing plate; and a coating on a surface of the friction lining, the coating comprising an adhesive, a lubricant, an iron oxide, an abrasive, and a filler.

Clause 2. The brake pad of clause 1, wherein the adhesive comprises a wood glue, a polymer resin, or a combination thereof.

Clause 3. The brake pad of clause 2, wherein the polymer resin comprises a phenolic resin, an acrylic resin, an epoxy resin, or a combination thereof.

Clause 4. The brake pad of any one of clauses 1-3, wherein the coating comprises the adhesive at about 50 weight percent (wt %) to about 85 wt % by weight of the coating.

Clause 5. The brake pad of any one of clauses 1-4, wherein the lubricant comprises an iron sulfide, a tin sulfide, or a combination thereof.

Clause 6. The brake pad of any one of clauses 1-5, wherein the coating comprises the lubricant at about 0.5 wt % to about 6 wt % by weight of the coating.

Clause 7. The brake pad of any one of clauses 1-6, wherein the iron oxide comprises magnetite (Fe₃O₄), iron(III) oxide (Fe₂O₃), iron(II) oxide (FeO), or a combination thereof.

Clause 8. The brake pad of any one of clauses 1-7, wherein the coating comprises the iron oxide at about 5 wt % to about 15 wt % by weight of the coating.

Clause 9. The brake pad of any one of clauses 1-8, wherein the abrasive comprises a zirconium silicate, zirconia, a magnesium oxide, a silica, silicon dioxide, a mineral silicate, or a combination thereof.

Clause 10. The brake pad of any one of clauses 1-9, wherein the abrasive comprises zirconium (Zr).

Clause 11. The brake pad of any one of clauses 1-10, wherein the coating comprises the abrasive at about 5 wt % to about 15 wt % by weight of the coating.

Clause 12. The brake pad of any one of clauses 1-11, wherein the filler comprises baryte, wollastonite, calcium carbonate, calcium fluoride, or a combination thereof.

Clause 13. The brake pad of any one of clauses 1-12, wherein the coating comprises the filler at about 1 wt % to about 32 wt % by weight of the coating.

Clause 14. The brake pad of any one of clauses 1-13, wherein the coating comprises, by weight of the coating, about 50 wt % to about 80 wt % of the adhesive, about 1 wt % to about 6 wt % of the lubricant, about 5 wt % to about 15 wt % of the iron oxide, about 5 wt % to about 15 wt % of the abrasive, and less than 32 wt % of the filler.

Clause 15. The brake pad of any one of clauses 1-14, wherein the coating does not include a titanate.

Clause 16. The brake pad of any one of clauses 1-15, wherein the coating comprises a material also present on a surface of the friction lining.

Clause 17. The brake pad of any one of clauses 1-16, wherein the friction lining comprises a semi-metallic material.

Clause 18. The brake pad of any one of clauses 1-17, wherein the friction lining comprises a tribological surface and is affixed to the surface of the backing plate such that the tribological surface is parallel to the surface of the backing plate within a specified tolerance.

Clause 19. The brake pad of any one of clauses 1-18, wherein the coating is affixed to a tribological surface of the friction lining using an adhesive, the coating being visually distinct from the friction lining, and wherein the coating creates a transfer layer of material onto a brake rotor during tribological contact of the brake pad and the brake rotor.

Clause 20. A method of making a brake pad, the method comprising: hot pressing a friction lining to a surface of a backing plate; heating the backing plate and the friction lining; and applying a coating to a surface of the friction lining, the coating comprising an adhesive, a lubricant, an iron oxide, an abrasive, and a filler.

What is claimed is:

1. A brake pad comprising:
a backing plate;
a friction lining affixed to a surface of the backing plate; and
a coating on a surface of the friction lining, the coating comprising
an adhesive,
a lubricant,
an iron oxide,
an abrasive, and
a filler.

2. The brake pad of claim 1, wherein the adhesive comprises a wood glue, a polymer resin, or a combination thereof.

3. The brake pad of claim 2, wherein the polymer resin comprises a phenolic resin, an acrylic resin, an epoxy resin, or a combination thereof.

4. The brake pad of claim 1, wherein the coating comprises the adhesive at about 50 weight percent (wt %) to about 85 wt % by weight of the coating.

5. The brake pad of claim 1, wherein the lubricant comprises an iron sulfide, a tin sulfide, or a combination thereof.

6. The brake pad of claim 1, wherein the coating comprises the lubricant at about 0.5 wt % to about 6 wt % by weight of the coating.

7. The brake pad of claim 1, wherein the iron oxide comprises magnetite (Fe₃O₄), iron(III) oxide (Fe₂O₃), iron(II) oxide (FeO), or a combination thereof.

8. The brake pad of claim 1, wherein the coating comprises the iron oxide at about 5 wt % to about 15 wt % by weight of the coating.

9. The brake pad of claim 1, wherein the abrasive comprises a zirconium silicate, zirconia, a magnesium oxide, a silica, silicon dioxide, a mineral silicate, or a combination thereof.

10. The brake pad of claim 1, wherein the abrasive comprises zirconium (Zr).

11. The brake pad of claim 1, wherein the coating comprises the abrasive at about 5 wt % to about 15 wt % by weight of the coating.

12. The brake pad of claim 1, wherein the filler comprises baryte, wollastonite, calcium carbonate, calcium fluoride, or a combination thereof.

13. The brake pad of claim 1, wherein the coating comprises the filler at about 1 wt % to about 32 wt % by weight of the coating.

14. The brake pad of claim 1, wherein the coating comprises, by weight of the coating,
about 50 wt % to about 80 wt % of the adhesive,
about 1 wt % to about 6 wt % of the lubricant,
about 5 wt % to about 15 wt % of the iron oxide,
about 5 wt % to about 15 wt % of the abrasive, and
less than 32 wt % of the filler.

15. The brake pad of claim 1, wherein the coating does not include a titanate.

16. The brake pad of claim 1, wherein the coating comprises a material also present on a surface of the friction lining.

17. The brake pad of claim 1, wherein the friction lining comprises a semi-metallic material.

18. The brake pad of claim 1, wherein the friction lining comprises a tribological surface and is affixed to the surface of the backing plate such that the tribological surface is parallel to the surface of the backing plate within a specified tolerance.

19. The brake pad of claim 1, wherein the coating is affixed to a tribological surface of the friction lining using an adhesive, the coating being visually distinct from the friction lining, and wherein the coating creates a transfer layer of material onto a brake rotor during tribological contact of the brake pad and the brake rotor.

20. A method of making a brake pad, the method comprising:
hot pressing a friction lining to a surface of a backing plate;
heating the backing plate and the friction lining; and
applying a coating to a surface of the friction lining, the coating comprising an adhesive, a lubricant, an iron oxide, an abrasive, and a filler.
